(19) United States
(12) Patent Application Publication
(10) Pub. No.: US 2003/0104222 A1
(43) Pub. Date: Jun. 5, 2003

(54) Silicon wafer and epitaxial silicon wafer

(76) Inventors: Toshiaki Ono, Tokyo (JP); Masataka Horai, Tokyo (JP)

Correspondence Address: CLARK & BRODY, Suite 600, 1750 K Street, NW, Washington, DC, 20006, US

(21) Appl. No.: 10/245,692

(22) Filed: Sep. 18, 2002

(30) Foreign Application Priority Data
Oct. 10, 2001 (JP) 2001-312092

(51) Int. Cl. B32B 9/04

(52) U.S. Cl. 428/446; 428/704; 428/332

(57) ABSTRACT

The invention relates to a silicon wafer and an epitaxial silicon wafer, which are doped with arsenic (As) as an n-type dopant and are excellent in gettering characteristics. A first silicon wafer has a resistivity of 10 Ωcm to 0.001 Ωcm as a result of addition of arsenic and has a nitrogen concentration of 1×10¹³ to 1×10¹⁵ atoms/cm³. A second silicon wafer has a resistivity of 0.1 Ωcm to 0.005 Ωcm and a nitrogen concentration of 1×10¹⁴ to 1×10¹⁵ atoms/cm³. A third silicon wafer has a resistivity of 0.005 Ωcm to 0.001 Ωcm and a nitrogen concentration of 1×10¹³ to 3×10¹⁴ atoms/cm³. An epitaxial silicon wafer derived from any of the first to third silicon wafers by forming an epitaxial layer in the surface layer portion is provided. In producing this epitaxial silicon wafer, epitaxial layer formation is desirably carried out after subjecting the silicon wafer to heat treatment for forming oxygen precipitates under conditions of a temperature not lower than 700° C. but lower than 900° C. and a period of 30 minutes to 4 hours. By these, an oxygen precipitate density can be secured and a sufficient gettering effect can be produced in the device producing process in spite of their being n-type silicon wafers doped with a high concentration of arsenic.

### FIELD OF THE INVENTION

The present invention relates to a silicon wafer and an epitaxial silicon wafer, which are to be used for the manufacture of semiconductor integrated circuit devices and, more particularly, to a silicon wafer and an epitaxial silicon wafer, which contain arsenic (As) added as an n-type dopant and are excellent in gettering characteristics.

### DESCRIPTION OF THE PRIOR ART

In recent years, the tendency toward higher degree of integration of silicon semiconductor integrated circuit devices has been rapidly increasing and, accordingly, silicon wafers on which devices are formed have been subjected to increasingly severe quality standards. Therefore, in manufacturing highly integrated devices, it is necessary to employ the so-called gettering technology which comprises trapping metal impurities at a site (in a sink) remote from the device active region, since the occurrence of crystal defects or metal impurities other than a dopant in the device active region where devices are to be formed leads to deterioration in electric characteristics, for example an increase in leakage current.

It is generally well known that, in p-type silicon wafers doped with boron (B) or the like, crystal defects including oxygen precipitates due to supersaturated interstitial oxygen, dislocations, and stacking faults, are induced in the device producing process. Therefore, an effect of gettering heavy metal impurities by oxygen-induced crystal defects which are spontaneously induced upon heat treatment in the device producing process, namely the intrinsic gettering (IG) effect, is produced in p-type silicon wafers.

On the contrary, in n-type silicon wafers doped with phosphorus (P) or antimony (Sb), it is reported by Wada et al. (Semiconductor Silicon, 1986, p. 778, H. R. Huff and T. Abe) that oxygen precipitation is suppressed as compared with p-type silicon wafers. According to such reports, the IG effect in n-type silicon wafers cannot be expected to be as high as in p-type silicon wafers.

Recently, epitaxial wafers derived from n-type silicon wafers doped with arsenic (As) by forming of an epitaxial layer thereon have been put to use as silicon wafers for MOSFETs or high peak inverse voltage bipolar ICs.

However, in n-type silicon wafers doped with arsenic, oxygen precipitation is suppressed within the wafer inside, like in the case of doping with phosphorus or antimony, and the level of oxygen precipitation is low. Therefore, those crystal defects which serve as gettering sources cannot be induced to a satisfactory extent within the wafer inside in the subsequent device producing process. In addition, wafers are subjected to heat treatment at a temperature as high as 1,050° C. to 1,200° C. in the epitaxial growing treatment step, so that oxygen precipitate nuclei inherent in the silicon wafers become smaller or disappear.

Thus, it is a problem of n-type silicon wafers doped with arsenic (As) that enough crystal defects to serve as gettering sources cannot be induced within the wafer inside, hence no satisfactory IG effect on metal impurities can be expected not only at the initial stage of the device producing process but over the whole producing process.

### SUMMARY OF THE INVENTION

It is an object of the present invention, which has been made in view of the problem mentioned above, to provide an n-type silicon wafer showing excellent gettering ability against heavy metals, which are sources of contamination, in the device producing process in spite of its being doped with arsenic (As) as well as an epitaxial silicon wafer derived from that silicon wafer by forming an epitaxial layer that is scant in defects in the epitaxial layer and very low in heavy metal concentration.

Methods of improving the IG capacity of silicon wafers by adding an impurity capable of promoting the growth of oxygen precipitation to the silicon crystal inside have so far been studied. For example, Japanese Patent Application Laid-open No. H11-189493 discloses a method of attaining a sufficient gettering effect without causing stable oxygen precipitate nuclei to disappear even upon high temperature heat treatment of wafers in the epitaxial growing step which method comprises causing a silicon single crystal doped with the p-type impurity boron to contain not less than 1×10¹³ atoms/cm³ of nitrogen.

However, this method does not teach at all that the gettering capacity (IG capacity) might be improved by adding nitrogen to an n-type silicon single crystal doped with arsenic.

To elucidate how arsenic (As) influences the behaviors of defects in silicon single crystals, the present inventors subjected silicon wafers with various levels of addition of arsenic to evaluation heat treatment and examined to which extent heat treatment-induced defects (BMD: bulk micro defects) had been formed within the wafer inside as a result of that heat treatment.

Specifically, silicon single crystals having an initial oxygen concentration of 14 to 16×10¹⁷ atoms/cm³ (ASTM F 121-79), a crystal orientation of (100) and a diameter of 150 mm were grown by the Czochralski method from silicon melts doped with arsenic so that the single crystals might have a resistivity of 10 Ωcm to 0.001 Ωcm. Wafers were sliced from the silicon single crystals and mirror-polished to give sample wafers.

Each sample wafer was subjected to evaluation heat treatment, namely isothermal heat treatment or two-stage heat treatment. The isothermal heat treatment comprised 1,000° C. (heating)/16 hours (maintenance) or 1,100° C./16 hours. The two-stage heat treatment includes four conditions, namely 600° C. (heating)/4 hours (maintenance)+1,000° C. (heating)/16 hours (maintenance), 700° C./4 hours+1,000° C./16 hours, 800° C./4 hours+1,000° C./16 hours, and 900° C./4 hours+1,000° C./16 hours.

After the above evaluation heat treatment, each wafer was cleaved and etched with a Wright etching solution for 5 minutes, and the wafer cleavage surface was examined for BMD density under an optical microscope.

FIG. 1 is a graphic representation of the relationship between resistivity and BMD density in the silicon wafer after evaluation heat treatment. The resistivity of the silicon wafer was adjusted by varying the level of addition of arsenic in the silicon melt. All the sample wafers were wafers produced under the same growing conditions including the oxygen concentration and so forth except that the level of addition of arsenic was varied.

As is evident from FIG. 1, with the increase in arsenic addition level in the silicon melt, hence with the decrease in wafer resistivity, the BMD density decreased, indicating the suppression of oxygen precipitation. This phenomenon can be explained based on the model according to the above-cited report of Wada et al. is which oxygen donors are regarded as precipitate nuclei. Thus, it is explained that while the oxygen donors release an electron upon their formation, the addition of an n-type impurity such as arsenic (As), which is a donor impurity, contributes in the direction of oxygen donor dissociation.

It is to be noted here that, with silicon wafers doped with a high concentration of arsenic and having a resistivity of not higher than 0.005 Ωcm, the BMD density tends to increase with the decrease in resistivity. Although the reason why the BMD density increases in that manner in the low resistivity range of not higher than 0.005 Ωcm is unknown, it is supposed that arsenic added in a high concentration for doping forms complexes with oxygen or aggregates of elemental arsenic within the wafer and these serve as heterogeneous nuclei for oxygen precipitation to increase the level of oxygen precipitation.

Based on the above conjecture, the present inventors made further intensive investigations and, as a result, found that, even in the case of arsenic-doped n-type silicon wafers, silicon wafers and epitaxial silicon wafers excellent in gettering capacity can be obtained by causing them to contain nitrogen in an appropriate concentration range depending on the wafer resistivity or, in other words, the arsenic addition level. In accordance with the present invention, nitrogen is added for the purpose of thermally stabilizing oxygen precipitate nuclei occurring in the wafer inside and promoting oxygen precipitation.

The present invention, which has been completed based on such findings, consists in the following silicon wafers (1) to (3) and epitaxial silicon wafers (4) to (6):

(1) A silicon wafer which has a resistivity of 10 Ωcm to 0.001 Ωcm as a result of addition of arsenic and has a nitrogen concentration of 1×10¹³ to 1×10¹⁵ atoms/cm³ (hereinafter referred to as “first silicon wafer”);

(2) A silicon wafer which has a resistivity of 0.1 Ωcm to 0.005 Ωcm as a result of addition of arsenic and has a nitrogen concentration of 1×10¹⁴ to 1×10¹⁵ atoms/cm³ (hereinafter referred to as “second silicon wafer”);

(3) A silicon wafer which has a resistivity of 0.005 Ωcm to 0.001 Ωcm as a result of addition of arsenic and has a nitrogen concentration of 1×10¹³ to 3×10¹⁴ atoms/cm³ (hereinafter referred to as “third silicon wafer”);

(4) An epitaxial silicon wafer derived from any of the first to third silicon wafers mentioned above by forming an epitaxial layer in the surface layer portion;

(5) An epitaxial silicon wafer as defined above under (4) which is derived, by forming epitaxial layer, from the silicon wafer subjected to heat treatment for forming oxygen precipitates; and

(6) An epitaxial silicon wafer as defined above under (5), wherein the heat treatment for forming oxygen precipitates is carried out at a temperature not lower than 700° C. but lower than 900° C. for 30 minutes to 4 hours.

### BRIEF DESCRIPTION OF THE DRAWING

FIG. 1 is a graphic representation of the relationship between resistivity (arsenic addition level being varied) and BMD density in the silicon wafer after evaluation heat treatment.

### DESCRIPTION OF PREFERRED EMBODIMENTS

In the first silicon wafer, the resistivity is controlled within the range of 10 Ωcm to 0.001 Ωcm by adjusting the level of addition of arsenic and the nitrogen concentration is controlled within the range of 1×10¹³ to 1×10¹⁵ atoms/cm³. By controlling in this manner, the addition of arsenic can result in stabilization of oxygen precipitate nuclei occurring in the wafer inside and promotion of oxygen precipitation.

Thus, as regards the first silicon wafer, the reduction in oxygen precipitation level within the wafer due to addition of arsenic can be lessened and a silicon wafer capable of showing high gettering ability even when subjected to heat treatment in the device producing process can be obtained. When the nitrogen concentration is below 1×10¹³ atoms/cm³, the effect of thermally stabilizing oxygen precipitates cannot be obtained and, when it exceeds 1×10¹⁵ atoms/cm³, the single crystal is converted to a polycrystalline state during the silicon single crystal growing process, resulting in a decrease in product yield.

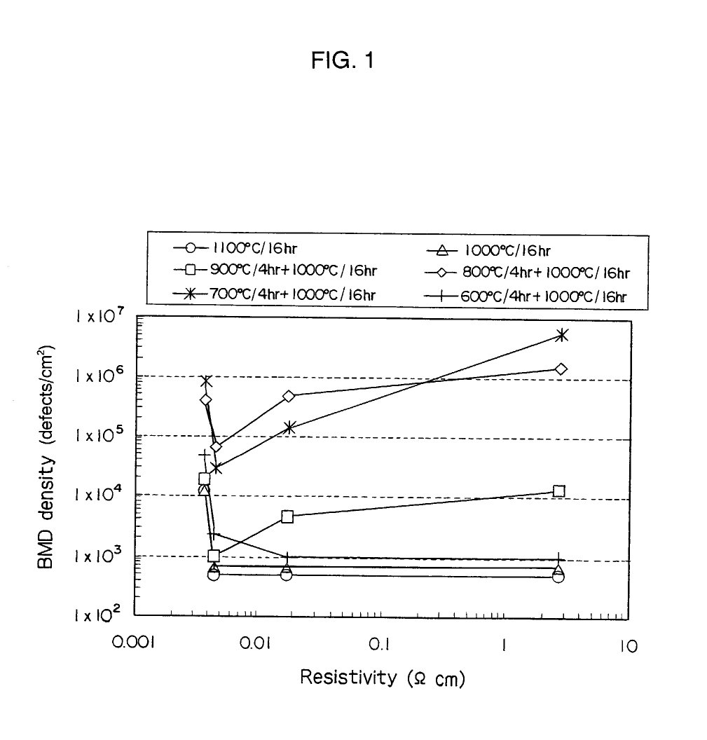

The second silicon wafer is a silicon wafer doped with a high concentration of arsenic so that the resistivity may amount to 0.1 Ωcm to 0.005 Ωcm. Therefore, with the decrease in resistivity, the oxygen precipitation tends to be suppressed, as shown in FIG. 1. Therefore, the nitrogen concentration is controlled in the high concentration range of 1×10¹⁴ to 1×10¹⁵ atoms/cm³ so that the oxygen precipitation can be prevented from being suppressed.

As a result, the second silicon wafer can become a silicon wafer capable of exhibiting a very high level of gettering ability even when subjected to heat treatment in the device producing process. When the nitrogen concentration is lower than 1×10¹⁴ atoms/cm³, the effect of thermally stabilizing oxygen precipitates cannot be produced, with the result that a crystal defect density of not lower than 1×10⁴ per cm² cannot be produced within the wafer.

The third silicon wafer is a silicon wafer doped with a higher concentration of arsenic so that the resistivity may amount to 0.005 Ωcm to 0.001 Ωcm and, therefore, there is a tendency toward promotion of oxygen precipitation with the decrease in resistivity, as shown in FIG. 1. Therefore, the addition of an unnecessarily excessive concentration of nitrogen induces oxygen precipitate formation in the wafer surface portion and deteriorates the surface quality. Therefore, when a higher concentration of arsenic is added to attain a resistivity of 0.005 Ωcm to 0.001 Ωcm, it is necessary that the nitrogen concentration be controlled within the low concentration range of 1×10¹³ to 3×10¹⁴ atoms/cm³.

As a result, the third silicon wafer can become a silicon wafer capable of exhibiting a very high level of gettering ability even when subjected to heat treatment in the device producing process. When the nitrogen concentration exceeds 3×10¹⁴ atoms/cm³, a crystal defect density of not lower than 1×10⁴/cm² can be produced within the wafer but oxygen precipitate formation is readily induced in the wafer surface portion, hence the wafer surface quality is deteriorated.

As explained hereinabove, the first to third silicon wafers according to the present invention, in which thermally stable oxygen precipitates are formed in sufficient amounts in the wafer inside, can serve as substrate wafers for the epitaxial silicon wafers of the present invention, giving epitaxial wafers which are excellent in gettering characteristics and have a good quality epitaxial layer free from contamination with metal impurities and in which oxygen precipitate nuclei within the wafer will not disappear even upon high-temperature heat treatment for epitaxial growing treatment.

The epitaxial silicon wafers of the present invention are desirably produced by using the first to third silicon wafers of the invention and by subjecting these to heat treatment for forming oxygen precipitates, followed by forming an epitaxial layer. By subjecting the silicon wafers to heat treatment for forming oxygen precipitates and then forming an epitaxial layer, it becomes possible to produce epitaxial silicon wafers particularly excellent in gettering capacity.

In the first to third silicon wafers, thermally stable oxygen precipitates are formed in the wafer inside as a result of the addition of nitrogen. However, they are small in size and small oxygen precipitates disappear upon high-temperature heat treatment in the step of epitaxial growing treatment. Therefore, in producing the epitaxial silicon wafers of the invention, it becomes possible to further improve the gettering capacity by subjecting the silicon wafers prior to epitaxial growing treatment to heat treatment for forming oxygen precipitates to thereby cause small-sized oxygen precipitates to grow to a size hardly allowing them to disappear upon high-temperature heat treatment in the step of epitaxial growing treatment.

The heat treatment for forming oxygen precipitates employed in accordance with the present invention is desirably carried out at a temperature not lower than 700° C. but lower than 900° C. for 30 minutes to 4 hours. By carrying out the heat treatment for forming oxygen precipitates under these conditions, the epitaxial silicon wafer of the invention can become a wafer truly excellent in gettering capacity.

In the heat treatment for forming oxygen precipitates, wafer contamination from the furnace may occur. For preventing such wafer contamination, it is effective to provide an oxide film as a protective film. For forming a protective film on the wafer, the heat treatment for forming oxygen precipitates is preferably carried out in a mixed gas atmosphere composed of oxygen and an inert gas.

Furthermore, when this heat treatment for forming oxygen precipitates is carried out prior to the step of mirror polishing of wafers, the oxide film on the wafer surface is removed in the mirror polishing step, so that a special step for removing the oxide film, for example an oxide film removing step using an HF solution, becomes unnecessary.

The oxygen concentration in the first to third silicon wafers is preferably not lower than 8×10¹⁷ atoms/cm³ (ASTM F 121-79) so that the wafer strength can be prevented from decreasing due to an insufficient oxygen concentration and, at the same time, an amount of oxygen precipitation necessary to obtain a sufficient IG effect can be secured. When the oxygen concentration is excessively high, oxygen precipitates are formed in the wafer surface layer and, when an epitaxial layer is formed on the surface of this wafer, oxygen precipitate-induced defects are produced in the epitaxial layer. Therefore, it is preferable to place the upper limit to the oxygen concentration at 18×10¹⁷ atoms/cm³ (ASTM F 121-79).

The first to third silicon wafers can be produced basically by employing the Czochralski method. By this method, it is possible to grow a silicon single crystal with the arsenic and nitrogen concentrations controlled within the respective specified ranges and obtain silicon wafers by slicing from this silicon single crystal. The step of preparing of the wafer and the step of forming an epitaxial film on the thus-obtained wafers by epitaxial growing treatment, which are to be employed in the practice of the present invention, are not particularly restricted. For example, any of the process steps and gaseous phase growing methods known in the art can be employed and an appropriate combination thereof can be applied.

Furthermore, as for the growth of silicon single crystals by the Czochralski method, since nitrogen is added in the practice of the present invention, it is not particularly necessary to carry out crystal pulling up while reducing the rate of pulling up so as to reduce the density of grown-in defects formed in the single crystal.

Further, the method of adding nitrogen to silicon single crystals is not particularly restricted provided that a desired concentration of nitrogen can be added thereto. For example, the incorporation of a nitride in the raw material or melt, the incorporation of FZ silicon crystals with nitrogen added or wafers having a silicon nitride film on the surface in the raw material, the single crystal pulling up in a nitrogen gas or nitrogen compound gas atmosphere, or the use of a nitride crucible may be employed.

As for silicon wafer processing, there are various steps, such as the slicing step for obtaining wafers by slicing a silicon single crystal, the step of beveling for preventing wafers from being chipped or cracked, the lapping step for flattening beveled wafers, the etching step for removing working induced strain layers generated in wafers in the above steps, the beveled portion polishing step for finish polishing of beveled portions, the surface grinding step for grinding one or both sides of wafers, and the mirror polishing step for finish polishing of wafers. These can be selected according to the use and quality of the silicon wafers and epitaxial silicon wafers, and such steps can be applied in appropriate combination.

### EXAMPLES

The effects of the silicon wafers and epitaxial silicon wafers according to the present invention are explained in Examples 1 and 2.

### Example 1

For examining the efficacy of nitrogen addition in arsenic-doped n-type silicon wafers, silicon wafers were prepared while varying the arsenic addition level and nitrogen concentration and, after evaluation heat treatment, each wafer was measured for wafer inside BMD density.

Specifically, silicon single crystals having an initial oxygen concentration of 11.5 to 18.5×10¹⁷ atoms/cm³ (ASTM F 121-79), a crystal orientation of (100) and a diameter of 150 mm were grown by the Czochralksi method from silicon melts while the arsenic addition level was varied to give a resistivity within the range of 0.018 Ωcm to 0.003 Ωcm and, simultaneously, the nitrogen concentration was varied.

Wafers were sliced from each silicon single crystal, and mirror polished sample wafers were prepared therefrom. Each sample wafer was subjected to evaluation heat treatment, namely isothermal heat treatment under conditions of 1,100° C. (heating)/16 hours (maintenance), the wafer was then cleaved and etched with a Wright etching solution for 5 minutes, and the wafer cleavage surface was examined for BMD density under an optical microscope. The examination results are shown in Table 1.

TABLE 1

| | | Oxygen | Nitrogen | |
|---|---|---|---|---|
| | Resistivity | concentration | concentration | BMD density |
| Specimen | (Ωcm) | (atoms/cm³) | (atoms/cm³) | (defects/cm²) |
| Sample 1 | 0.018 | 18.5 × 10¹⁷ | 4 × 10¹³ | <1 × 10³ |
| Sample 2 | 0.016 | 17.3 × 10¹⁷ | 6 × 10¹³ | <1 × 10³ |
| Sample 3 | 0.011 | 16.1 × 10¹⁷ | 1.6 × 10¹⁴ | 4 × 10⁴ |
| Sample 4 | 0.004 | 16.2 × 10¹⁷ | 1 × 10¹³ | 2.1 × 10⁴ |
| Sample 5 | 0.003 | 11.8 × 10¹⁷ | 8.7 × 10¹³ | 3.5 × 10⁵ |

As is evident from the results shown in Table 1, not lower than 1×10⁴ BMDs/cm² were formed in the wafers having a resistivity of not lower than 0.010 Ωcm as a result of addition of arsenic when the nitrogen concentration was not lower than 1×10¹⁴ atoms/cm³. When the resistivity was not more than 0.005 Ωcm, not lower than 1×10⁴ BMDs/cm² were formed when the nitrogen concentration was not lower than 1×10¹³ atoms/cm³.

### Example 2

For examining the efficacy of nitrogen addition in epitaxial silicon wafers derived from arsenic-doped n-type silicon wafers by forming epitaxial layer, silicon wafers were prepared while varying the arsenic addition level and nitrogen concentration, and the silicon wafers were subjected to epitaxial growing treatment. The thus-produced epitaxial silicon wafers were subjected to evaluation heat treatment and then measured for the density of BMDs formed in the wafer inside. Epitaxial silicon wafers derived from the silicon wafers subjected to heat treatment for forming oxygen precipitates prior to epitaxial growing treatment were also measured for BMD density.

Specifically, silicon single crystals having an initial oxygen concentration of 8 to 18.5×10¹⁷ atoms/cm³ (ASTM F 121-79), a crystal orientation of (100) and a diameter of 150 mm were grown by the Czochralksi method from silicon melts while the arsenic addition level was varied to give a resistivity within the range of 0.018 Ωcm to 0.003 Ωcm and the nitrogen concentration was varied. Wafers were sliced from each silicon single crystal and mirror polished. On the silicon wafers obtained, there was grown an epitaxial layer having a thickness of about 18 μm by the vapor phase growing method at a deposition temperature of 1,150° C., whereby epitaxial silicon wafers were produced.

Separately, silicon wafers prior to epitaxial growing treatment were subjected to heat treatment for forming oxygen precipitates, namely 30 minutes of heat treatment at 880° C. and, then, an epitaxial layer having a thickness of about 18 μm was grown thereon by the gaseous phase growing method at a deposition temperature of 1,150° C. to give epitaxial silicon wafers.

Each of the epitaxial silicon wafers thus obtained was subjected to evaluation heat treatment at 1,000° C. for 16 hours, the wafer was then cleaved and etched with a Wright etching solution for 5 minutes, and the bulk wafer cleavage surface was examined for BMD density under an optical microscope. The examination results are shown in Table 2.

TABLE 2

| | | | | Oxygen | |
|---|---|---|---|---|---|
| | | | | precipitates | |
| | | Oxygen | Nitrogen | forming | |
| | Resistivity | concentration | concentration | heat | BMD density |
| Specimen | (Ωcm) | (atoms/cm³) | (atoms/cm³) | treatment | (defects/cm²) |
| Sample 6 | 0.017 | 18.5 × 10¹⁷ | No addition | No | <1 × 10³ |
| Sample 7 | 0.015 | 17.0 × 10¹⁷ | No addition | No | <1 × 10³ |
| Sample 8 | 0.011 | 16.1 × 10¹⁷ | No addition | No | <1 × 10³ |
| Sample 9 | 0.004 | 15.3 × 10¹⁷ | No addition | No | 2.1 × 10³ |
| Sample 10 | 0.003 | 12.5 × 10¹⁷ | No addition | No | 7.3 × 10³ |
| Sample 11 | 0.018 | 17.5 × 10¹⁷ | 1.3 × 10¹⁴ | No | 3 × 10⁴ |
| Sample 12 | 0.011 | 12.0 × 10¹⁷ | 8.5 × 10¹⁴ | No | 7.8 × 10⁵ |
| Sample 13 | 0.005 | 14.3 × 10¹⁷ | 2.8 × 10¹³ | No | 6 × 10⁴ |
| Sample 14 | 0.004 | 11.3 × 10¹⁷ | 8.5 × 10¹³ | No | 8 × 10⁵ |
| Sample 15 | 0.003 | 8.0 × 10¹⁷ | 9.8 × 10¹³ | No | 4.3 × 10⁴ |
| Sample 16 | 0.018 | 17.5 × 10¹⁷ | 1.3 × 10¹⁴ | Yes | 1.6 × 10⁶ |
| Sample 17 | 0.016 | 12.0 × 10¹⁷ | 8.5 × 10¹⁴ | Yes | 1.9 × 10⁶ |
| Sample 18 | 0.011 | 14.3 × 10¹⁷ | 2.8 × 10¹³ | Yes | 3.5 × 10⁶ |
| Sample 19 | 0.004 | 11.3 × 10¹⁷ | 8.5 × 10¹³ | Yes | 4.5 × 10⁶ |
| Sample 20 | 0.003 | 8.0 × 10¹⁷ | 9.8 × 10¹³ | Yes | 1.2 × 10⁶ |

As is evident from the results shown in Table 2, the epitaxial silicon wafers (Samples 6 to 10) derived from the substrate wafers with no nitrogen added showed low BMD density values irrespective of resistivity or oxygen concentration. On the contrary, in all the epitaxial silicon wafers (Samples 11 to 15) derived from the substrate wafers containing added nitrogen, not lower than 1×10⁴ BMDs/cm² were detected and, in all the epitaxial silicon wafers (Samples 16 to 20) derived from the substrate wafers containing added nitrogen and subjected to oxygen precipitates forming heat treatment prior to epitaxial growing treatment, not lower than 1×10⁶ BMDs/cm² could be secured.

As explained hereinabove, the silicon wafers according to the invention can secure an oxygen precipitate density and produce a sufficient gettering effect in the device producing process in spite or their being n-type silicon wafers doped with a high concentration of arsenic.

Further, the epitaxial silicon wafers according to the present invention, which are derived from the above silicon wafers by forming epitaxial layer, can secure an oxygen precipitate density and produce a sufficient gettering effect in the device producing process.

What is claimed is:

1. A silicon wafer which has a resistivity of 10 Ωcm to 0.001 Ωcm as a result of addition of arsenic and has a nitrogen concentration of 1×10¹³ to 1×10¹⁵ atoms/cm³.

2. A silicon wafer which has a resistivity of 0.1 Ωcm to 0.005 Ωcm as a result of addition of arsenic and has a nitrogen concentration of 1×10¹⁴ to 1×10¹⁵ atoms/cm³.

3. A silicon wafer which has a resistivity of 0.005 Ωcm to 0.001 Ωcm as a result of addition of arsenic and has a nitrogen concentration of 1×10¹³ to 3×10¹⁴ atoms/cm³.

4. An epitaxial silicon wafer produced from a silicon wafer which has a resistivity of 10 Ωcm to 0.001 Ωcm as a result of addition of arsenic and has a nitrogen concentration of 1×10¹³ to 1×10¹⁵ atoms/cm³, by forming of an epitaxial layer in the surface layer portion thereof.

5. An epitaxial silicon wafer as claimed in claim 4 which is produced by forming epitaxial layer on the silicon wafer after heat treatment for forming oxygen precipitates.

6. An epitaxial silicon wafer as claimed in claim 5, wherein the heat treatment for forming oxygen precipitates is carried out at a temperature not lower than 700° C. but lower than 900° C. for 30 minutes to 4 hours.

7. An epitaxial silicon wafer produced from a silicon wafer which has a resistivity of 0.1 Ωcm to 0.005 Ωcm as a result of addition of arsenic and has a nitrogen concentration of 1×10¹⁴ to 1×10¹⁵ atoms/cm³, by forming an epitaxial layer in the surface layer portion thereof.

8. An epitaxial silicon wafer as claimed in claim 7 which is produced by forming epitaxial layer on the silicon wafer after heat treatment for forming oxygen precipitates.

9. An epitaxial silicon wafer as claimed in claim 8, wherein the heat treatment for forming oxygen precipitates is carried out at a temperature not lower than 700° C. but lower than 900° C. for 30 minutes to 4 hours.

10. An epitaxial silicon wafer produced from a silicon wafer which has a resistivity of 0.005 Ωcm to 0.001 Ωcm as a result of addition of arsenic and has a nitrogen concentration of 1×10¹⁴ to 3×10¹⁴ atoms/cm³, by forming an epitaxial layer in the surface layer portion thereof.

11. An epitaxial silicon wafer as claimed in claim 10 which is produced by epitaxial layer formation on the silicon wafer after heat treatment for forming oxygen precipitates.

12. An epitaxial silicon wafer as claimed in claim 11, wherein the heat treatment for forming oxygen precipitates is carried out at a temperature not lower than 700° C. but lower than 900° C. for 30 minutes to 4 hours.
